(19) United States
(12) Patent Application Publication
(10) Pub. No.: US 2025/0068224 A1
(43) Pub. Date: Feb. 27, 2025

(54) FAST COMPUTE DIE ICC LIMIT TECHNIQUES

(71) Applicants: Rene BARRIENTOS BARRIENTOS, Hillsboro, OR (US); Fabrice PAILLET, Portland, OR (US); Liang Kim GOH, San Jose, CA (US); Dana COFFMAN, Portland, OR (US); Andre SOTOLONGO, Beaverton, OR (US); Philip LEHWALDER, Hillsboro, OR (US); Nimrod ANGEL, Haifa (IL)

(72) Inventors: Rene BARRIENTOS BARRIENTOS, Hillsboro, OR (US); Fabrice PAILLET, Portland, OR (US); Liang Kim GOH, San Jose, CA (US); Dana COFFMAN, Portland, OR (US); Andre SOTOLONGO, Beaverton, OR (US); Philip LEHWALDER, Hillsboro, OR (US); Nimrod ANGEL, Haifa (IL)

(21) Appl. No.: 18/373,674

(22) Filed: Sep. 27, 2023

Related U.S. Application Data
(60) Provisional application No. 63/533,874, filed on Aug. 21, 2023.

(51) Int. Cl. G06F 1/3206; G06F 1/324; G06F 15/78

(52) U.S. Cl. CPC G06F 1/3206; G06F 1/324; G06F 15/781

(57) ABSTRACT

In some embodiments, techniques for providing fast integrated circuit current limits are provided.

### CROSS-REFERENCE TO RELATED APPLICATIONS

This application claims the benefit of U.S. Provisional Application No. 63/533,874, filed Aug. 21, 2023, which is hereby incorporated by reference.

### TECHNICAL FIELD

Embodiments of the invention relate to the field of computing platforms; and more specifically to current limiting techniques for SoCs and SoC domains.

### BRIEF DESCRIPTION OF THE DRAWINGS

The invention may best be understood by referring to the following description and accompanying drawings that are used to illustrate embodiments of the invention. In the drawings:

FIG. 1 is a block diagram of a SoC in accordance with some embodiments.

FIG. 2A is a block diagram of a portion of a compute platform with fast VR load current reduction in accordance with some embodiments.

FIG. 2B is a graph showing a load-line curve and throttle response operations for a VR and VR rail load of the platform of FIG. 2A in accordance with some embodiments.

FIG. 3A is a block diagram showing a portion of a SoC compute platform with a current limited VR and a fast SoC droop detect capability in accordance with some embodiments.

FIG. 3B is a block diagram showing the SoC portion 305 from FIG. 3A with additional features in accordance with some embodiments.

FIG. 4 illustrates an example computing system that may incorporate combinations of processor system power and performance management features described herein.

FIG. 5 illustrates a block diagram of an example processor and/or SoC that may have one or more cores and an integrated memory controller for use with embodiments of the system of FIG. 4.

### DETAILED DESCRIPTION

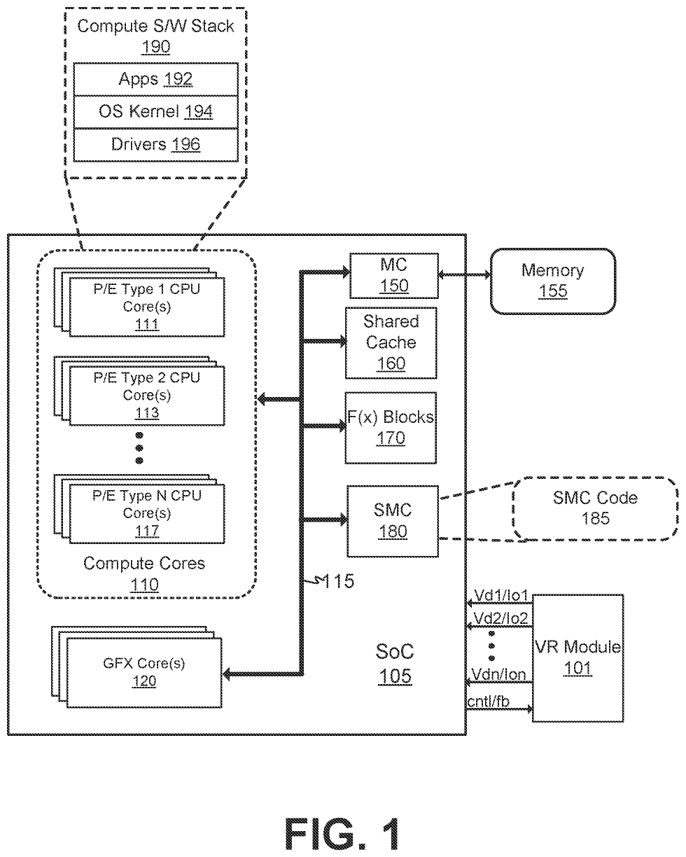

FIG. 1 is a block diagram of a SoC system in accordance with some embodiments. The system includes one or more SoC dies 105, with at least one being coupled to a VR Module 101 to supply “n” regulated voltage supplies (Vdi) to “n” VR loads within the SoC. The system is also designed to be coupled with external memory 155, along with other devices such as user interface peripheral devices, displays, and the like (not shown for simplicity).

The SoC 105 generally includes compute (or CPU) cores 110 with associated local cache (not shown), graphics processing core(s) (GFX) 120, also with associated cache (not shown), system management controller circuit (hereinafter referred to as “SMC) 180, various functional (f(x)) blocks 170, shared cache (e.g., last level cache) 160, and memory controller 150, communicatively coupled together through communications fabric 115, which may be implemented with one or more busses, rings, and/or mesh networks, depending upon particular design configurations and objectives.

The SMC 180 includes one or more microcontrollers, state machines and/or other logic for controlling various aspects of the SoC system 105. For example, it may manage functions such as security, boot configuration, thermal management, and power and performance management including utilized and allocated power, (Note that the SMC may also be referred to as a P-unit, a power management unit (PMU), a power control unit (PCU), a system management unit (SMU) and the like and may include multiple SMCs, PMUs, die management controllers, etc.) The SMC executes SMC code 135 which may include multiple separate modules and/or logic to perform these and other functions.

The compute (e.g., CPU) cores 110 may include different core types (or classes) with regard to their design bias toward performance or efficiency. There are N different P/E core types, as shown. For example, P/E type 1 CPU cores (111) may be of a highest performance class, e.g., having floating point and/or other robust execution features but consuming relatively large amounts of power, wile P/E type 2 CPU cores (113) may have slightly lower performance capabilities but be more power efficient. Likewise, the other core types, on down to type N CPU cores (117), may be designed for greater efficiency but with less performance capability. In some embodiments, having these different P/E core types may be referred to as a hybrid processing system implementation. Note that in many implementations, the different P/E type compute cores, while having different power/performance profiles, may have a common instruction set architecture (ISA). In other embodiments, one or some of the different P/E core types may utilize different ISAs relative to the other P/E compute core types.

It should be appreciated that the SoC system 105 may be implemented in various different manners. For example, it may be implemented on a single die, multiple dies (dielets, chiplets), one or more dies in a common package, or one or more dies in multiple packages. Along these lines, some of these blocks may be located separately on different dies or together on two or more different dies. In some embodiments, however, with multi-die implementations, each die may have its own SMC or SMC instantiation with the same, or more or less, features and responsibilities as the other die SMCs.

Also shown is a compute software stack 190 that may wholly or partially be executed within compute cores 110. Software stack 190 includes applications (Apps) 192, operating system kernel 194, and drivers 196. The OS 194 and drivers 196 may work together with the SMC(s) 180 to manage power and performance (PnP) of the various blocks within SoC system.

As will be discussed below, SoC system 105 may have different features or feature combinations to limit internal VR load current and avoid drawing excessive current from the VR load's associated VR, thereby preventing a VR over-current shutdown event from occurring. It should be appreciated that a VR load may include any SoC block or block combination powered from a common VR rail. For example, in some embodiments, a VR from VR module 101 may be used to supply power through a VR rail to at least some of the CPU cores, which may constitute a VR load for that VR. On the other hand, a VR supplying all of the power to a SoC or SoC die might have an associated VR load made up of the entire SoC or SoC die, respectively. Alternatively, a VR load might be formed from a subset of blocks being powered by a VR. For example, the subset may consume most of the VR's current and thus all of the loads from the entire VR rail may not be needed for current control monitoring.

When a SoC demands current at or above the rated IoMax for the given Voltage regulator, there is a risk of a VR voltage collapse, which can crash the SoC. Historically this problem has been addressed by the power management/control logic (e.g., in an SMC) constraining the maximum allowed (or requested) Io value that corresponds to the current sourcing capability of the VR supplying the Io current. Unfortunately, the max. allowed Io value is commonly based on a roughly estimated worst-case current loading scenario, provisioning enough margin to ensure the VR will not shut down due to an over current condition. That is, the SMC dynamically provisions current using forward-looking heuristics based on expected worse-case events that might or might not happen, and thus, the platform VR module may be over-designed based on excessive current allocation estimations. This can result in both a platform using an over-sized (and more expensive) VR module, and/or it can also result in the SoC unduly constraining its operations to avoid over-current conditions that will likely never or at least very rarely ever occur. Accordingly, techniques are provided to allow a SoC to run closer to maximum rated power consuming parameters (e.g., higher allowed average current, higher performance) even if it means that the Io approaches, or even exceeds on occasion, maximum rated VR current sourcing capabilities without a meaningful risk of causing a VR over-current shutdown.

In some embodiments, the VR is provisioned with an Io limit threshold, beyond which no additional current will be sourced by the VR itself. When the SoC load attempts to draw current above this threshold, decoupling capacitors may provide supplemental current for a period of time. In many cases, this will be enough to satisfy SoC current load demand since such high current events are, in many instances, spikes, or bursts, happening intermittently. Even if the over-current load lasts beyond the capabilities of the current limited VR and capacitors, the SOC has a voltage droop monitor in line with the VR's input rail to detect voltage drops when the supply current exceeds the VR's limits. The droop detector can initiate a fast trigger that can send heavy demand SoC IP domains (sourced by the VR) into a power-reducing throttle condition. If the over-current conditions persist, an SMC can then take longer lasting measures to limit power consumption, e.g., it can reduce operating point assignments, and as a last resource, the VR itself may be capable of asserting its own fast-throttle to the SoC.

In this way, platform designers will be able to undersize the SoC VRs, or alternatively, SoC designers may be freed up to run a SoC at higher average performance levels given the same VR max. current sourcing capabilities, without having to worry about a VR shutoff event.

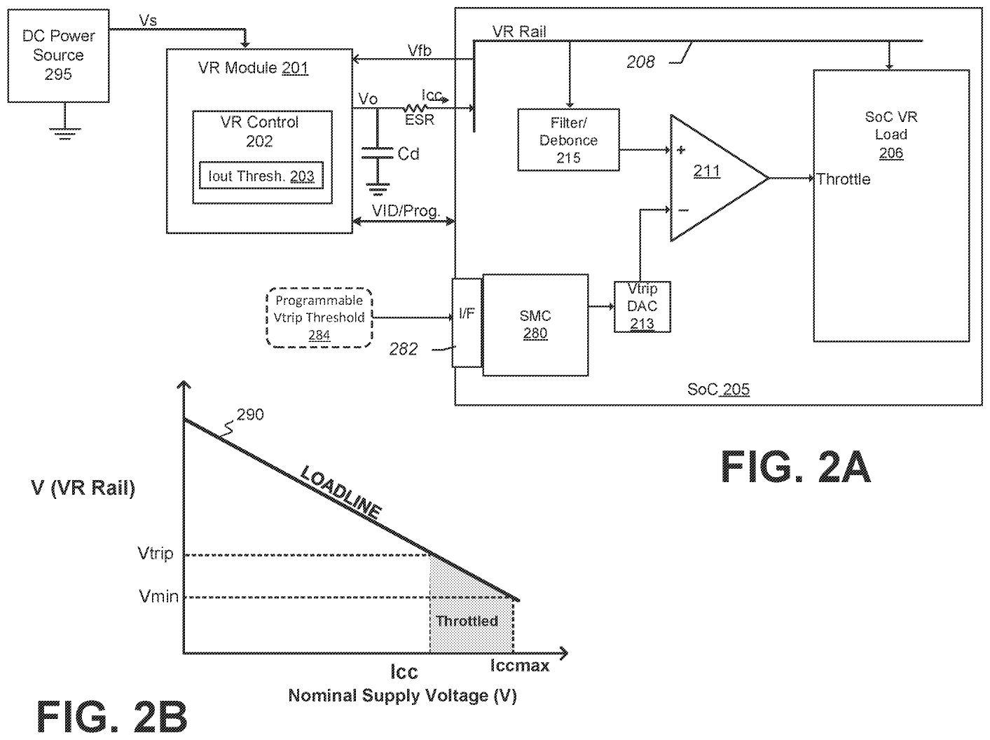

FIG. 2A is a block diagram showing a portion of a SoC compute platform with a current limited VR and a fast SoC droop detect functionality in accordance with some embodiments. The platform generally includes a SoC die 205, and a VR module 201 coupled to the SoC to provide it with a regulated output voltage (Vo) over at least one VR rail (208) within the SoC. (Note that the VR module may actually include multiple VRs to provide multiple VR rails to a SoC system or SoC die but for simplicity, only one VR rail is presented in this description. For example, the depicted VR rail could correspond to a compute, e.g., CPU, complex rail for supplying power to multiple compute cores in the SoC. Other VR rails, for example, might supply power to GFX core domains, system agent domains, etc.) The depicted platform also includes a DC power source such as an adaptor, battery, or combination of AC adaptor and battery 295 for supplying the VR module with a DC power source (Vs). Also shown is a decoupling capacitance (Cd) that may be part of the VR module and/or comprise external capacitor(s), for example, coupled as shown mounted on a motherboard or PCB (printed circuit board) outside of the VR module. Ideally, the decoupling capacitance will be sufficient for supplementing current to the SoC when the VR goes into a current limit mode for a desired period of operation, which will depend on particular design conditions and objectives. There is additionally shown an effective series resistance (ESR) that represents the inherent resistance/impedance of the physical connectivity between the VR output and SoC supply input.

The VR module 201 may include one or more VRs including buck type voltage regulators using one or multiple phases. In some embodiments, the VR for supplying the VR rail (208) is a multi-phase buck-type VR that is capable of operating in current limited, constant current mode, as well as in one or more steady-state voltage regulation modes, e.g., CCM (continuous current mode), DCM (discontinuous current mode), etc. when the load current is below the current limit threshold. The VR module also has a control circuit 202 with an Iout threshold (or limit) 203 for switching into a limited, constant current mode, at the lout threshold level value, when its current reaches this threshold value. In some embodiments, the Iout threshold 203 may be a programmable value in control circuit 202 memory or in other non-volatile or volatile memory accessible by the control circuit.

The SoC 205 includes a SoC VR load 206 powered from the VR rail (208), along with VR rail droop response circuitry formed from analog comparator 211, Vtrip DAC 213, and filter/debounce circuit 215, coupled as shown. The SoC also includes a SMC 280 with interface 282, which among other things, may be used to program (284) a Vtrip level that determines the VR rail voltage droop level that is to cause the droop circuit to activate and quickly reduce power in the SoC load 206. The SC VR load 206 corresponds to one or more functional blocks such as core clusters, processing units, memory, IP blocks, etc. For example, it may correspond to a plurality of compute core clusters, or it could correspond to most if not all of the functional blocks in a SoC.

In this depiction, the SMC applies the programmed Vtrip value to the DAC 213. When the VR rail voltage is sufficiently sustained below the Vtrip level to get past the filter/debounce circuit 215, it causes comparator 211 to assert (or activate) a throttle signal for the SoC VR load 206 to cause its power consumption to quickly reduce. The throttle may actually initiate one or more throttle signals within the load to assert, depending on the make-up and configuration of the load. For example, the load may comprise several different functional blocks such as core complexes, memory, IP (intellectual property) blocks, and other functional blocks, all ultimately powered from the VR rail 208. Each block may have its own mechanism for throttling and will initiate the mechanism in response to the throttle signal from comparator 201 being asserted. (It should be appreciated that the term “throttle” is used generally to encompass any suitable scheme for quickly reducing power in a functional block without unduly inhibiting its functionality as much as is possible. For example, operating frequencies for executing cores may be reduced without having to re-lock PLLs or flushing cache or pipeline registers. For example, they may be reduced through clock synthesis logic or by applying clock stretching techniques. To appreciate such throttling techniques, it should be remembered that a throttle event can occur over a very short time window, e.g., tens or hundreds of nano-seconds.)

With additional reference to FIG. 2B, in operation, the VR control circuit 202 causes the VR to enter into a constant current mode when its output current exceeds an lout threshold 203. When this mode triggers, there is an implicit current difference between the current that the SoC VR load is consuming and the current that the VR is supplying. This deficit will temporarily be sustained by the decoupling capacitance, but if the drawn current demand persists, the capacitance discharges, resulting in the VR rail voltage going down, as illustrated in FIG. 2B. Before the VR rail voltage goes below a minimum operational voltage needed to avoid SoC shutdown, however, it will first cross the Vtrip threshold, which triggers the throttling at comparator 211, thereby quickly reducing current consumption and keeping the VR rail voltage above the minimum required level to avoid a system crash.

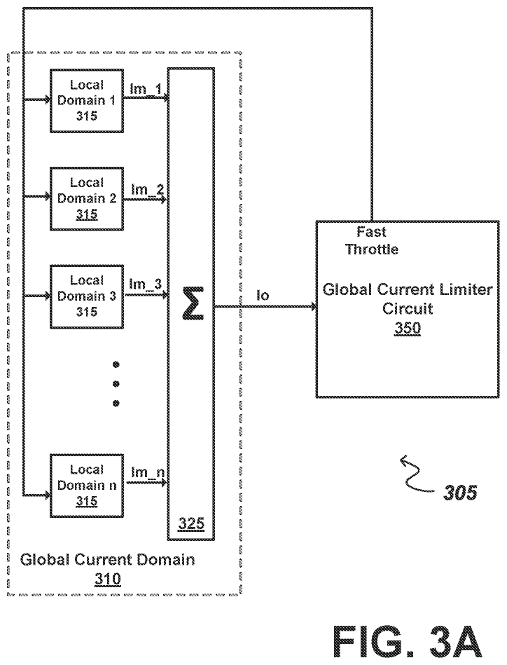

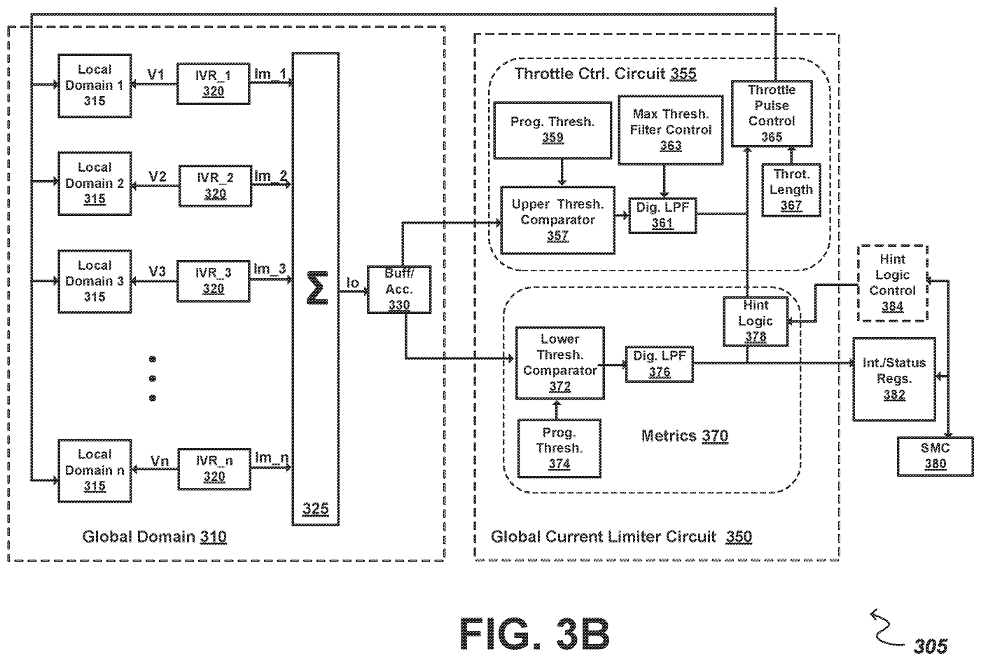

With reference to FIGS. 3A and 3B, an internal hardware-based current limiter is provided to limit the overall current in a global current domain, for among other reasons, to be able to operate the global domain as close as possible to the maximum current capabilities of the VR source (e.g., external source) supplying it without triggering its over-current mechanisms. It essentially tracks an indirect proxy of the overall current supplied by the global domain VR by monitoring and limiting the combined current consumed by some or all of its supplied individual local domain loads. This can allow an SMC to make intelligent decisions to optimized for max current, low power and max performance within the global domain VR's output maximum current constraints.

FIG. 3A is a block diagram showing a portion 305 of a SoC die with fast internal current protection in accordance with some embodiments. The SoC includes a die with a monitored global current domain 310 and a global current limiter circuit 350 for monitoring and limiting the overall current in the global domain 310. Global domain 310 includes “n” local current domains 315 each generating a monitored current (Im_i) coupled to adder circuit 325, which adds all of the monitored local domain currents together to generate an overall global domain current (Io, also referred to as overall current level). Each local domain 315 has an associated fast current sense capability for providing the monitored current value (Im_i) to the adder circuit 325. In some embodiments, the monitored current values (Im_i) are digital values that track their associated local domain currents. In some embodiments, the local domain currents are continually fed into, or read by, adder 325 over a sufficiently robust bus, e.g., 9 to 12 bits running at 4 MHz. Among other things, this can allow for very fast current tracking with very little delay (e.g., 100 nS) from the local domain current values, as they are sensed, to the adder output.

(Note that as used herein, a local, or local current, domain refers to a group of circuits, usually part of one or more common functional blocks, that are supplied by a common supply rail and thus have an associated current that is being sourced through that rail. An integrated circuit (IC) such as a SoC or SoC die may have few or many different local domains. Along these lines, an IC may have one or more different global domains, each with a plurality of associated local domains with one or more of the global domains monitored and limited as taught herein. In some embodiments, when one global domain is monitored and limited (e.g., a global domain for a whole IC die), it may be configured so as to include local domains with significant current consumption and thereby, together, substantially reflecting overall IC current consumption. Note that not every possible local domain in an IC need be part of a monitored global domain.)

In some embodiments, the adder may be configured in a tree-like structure with different sub-adder circuits aggregated together to generate the overall (global) current level (Io). (Note that the phrase “current level”, as used herein, refers to both the current signal and the value of the signal at any relevant point in time, e.g., when measured, processed, compared, etc. Accordingly, the adder provides the overall current level at its output. When a digital output is employed, the overall current level (I.) is a digital signal, a train of individual current levels, or values.)

In some cases, a global domain will occupy a relatively large area of a SoC die. It may be effective to distribute lower-level, sub-adders about the SoC to collect their associated local domain currents and couple them, e.g., through multiplexers, flops, etc., to upper level adder circuits, eventually arriving at the overall resultant current level (Io). For example, adder circuits with two inputs could be employed to sum together local domain currents (Im_i), two values at a time and feeding the results up the adder structure levels. Among other things, this enables the adder to be physically distributed about the die proximal to the various local domain current monitoring circuitry. In order to achieve a fast and effective adder solution, adder circuit 325 (including constituent sub-adder and routing circuitry) may include combinational logic circuits such as Boolean gates, multiplexers, and sequential logic circuits such as flops, as well as other circuit elements such as repeaters, buffers, and synchronizers to facilitate robust data transfer rates over the utilized bus fabric.

The global current limit circuit 350 receives the overall current level (Io) and compares it against one or more thresholds. For example, it may include a digital comparator to compare the Io level against an upper (max) threshold level. If this level is exceeded, the limiter circuit may then assert a throttle signal that is coupled to the local domain circuit blocks, which causes them to throttle down their power consumption and thereby reduce the overall global domain current. In this way, a fast current limit control loop is facilitated at least somewhat independent of higher level, slower control modules such as the OS or even the SMC. Along these lines, the limiter circuit should be implemented with sufficiently fast circuit components (digital and/or analog) that in cooperation with the responsiveness of the local domain current sense signals and adder circuitry, allow for a sufficiently fast overall current limit control loop.

In addition, the limiter circuit may have various components for filtering monitored Io level spikes and/or for adjusting the intensity of the asserted throttle signal, based on any suitable factors, e.g., settings from an SMC controller, or burned into the SoC during a manufacturing phase.

FIG. 3B is a block diagram showing the SoC portion 305 from FIG. 3A with additional features in accordance with some embodiments. The global domain monitoring circuit 310 includes the “n” local domains 315, along with the adder circuit 325. In addition, with this implementation, it also includes integrated voltage regulators (IVRs) 320 that are each coupled to an associated local domain circuit 315 to provide it with power. The IVRs receive their supply power from one or more higher-level VRs (not shown). For example, they could receive power from one or more off-chip or external voltage regulators. In some embodiments, the global domain 315 could correspond to a VR load such as VR load 206 from FIG. 2.

Each of the IVRs 320 may have its own fast current monitoring (or sense) capability for generating the monitored local domain current values. In some embodiments, the monitored current values (Im_i) are digital values that track the generated current by their associated IVR. For example, the IVRs may be implemented with digital or at least partially digital voltage regulators such as a digital linear voltage regulator (DLVR) or a digital LDO (low drop-out) VR. Some digital or hybrid VRs provide current controlled digitally selectable legs of current to their IP loads and thus, at any given time, their current (I) output may be read (directly or indirectly) from the applied digital value controlling the legs. It should be appreciated that there are other digitally controlled configurations whereby the controlling digital value sufficiently corresponds to the actual real-time current being supplied by the VR. Alternatively, in other embodiments, the IVRs could include current sensing capabilities with digital outputs, e.g., analog current sensors with fast A/D converters.

The local domain current signals (Im_i) are provided to adder 325, which adds them together and generates an overall current value (Io), which in this depicted implementation, is provided to buffer/accumulator circuit 330. In some embodiments, the accumulator buffers a continuous, moving window of overall (Io) values that are in turn made available to the current limiter circuit 350. Depending on the implementation used for adder 325, the accumulator may sample and generate clocked Io values, it may simply pass on the already clocked Io values, it may act as a clock crossing circuit and combine values into Io packets with a different clock frequency from that of the adder, it may average values within sub-windows within the accumulator window, or it may act on the Io value in other ways suitable for specific limiter circuit implementations and/or other design objectives. In some embodiments, the limiter circuit 350 may be able to tune accumulator 330 or otherwise modify its settings to change the configuration of the Io signal that it generates and provides to limiter 350.

In the depicted embodiment, the global current limit circuit 350 generally includes throttle control circuit 355 and SMC metrics circuit 370, both of which may be coupled to an SMC 380 through an interrupt/status register interface including interrupt and status registers (e.g., MSRs) 382 accessible by the SMC 380.

The throttle control circuit 355 includes an upper limit threshold comparator 357, programmable threshold interface 359, digital low pass filter (LPF) 361, filter control circuit 363, throttle pulse control circuit 365, and throttle length control block 367, coupled together as shown.

In the depicted embodiment, the upper threshold comparator is a digital comparator that compares the incoming Io signal against a threshold limit (max) that is defined through a programmable threshold interface 359. For example, this could be programmed during manufacture through hardened values (e.g., fuses, ROM) or it could be programmed through a BIOS or other updateable interface. The upper threshold comparator generates an output that is provided to the dig. LPF 361. When the Io signal goes above the upper threshold, the comparator asserts (e.g., High) at its output. The dig. LPF functions to filter out noise, unwanted “false alarms” by requiring a certain assertion density or sustained sequence of assertions before generating an assertion at its output, which is provided to throttle pulse control circuit 365. The filter control circuit 363 allows for adjustment of the LPF, e.g., increasing or decreasing its cut-off parameters.

The throttle pulse control circuit 365 generates a pulse at its output when an assertion is received from the dig. LPF 361. The length of the pulse may be set by a pulse length interface 367. This interface may set a fixed pulse length, e.g., during manufacture, or alternatively, it could be set/updated at start-up, or it could be dynamically controlled, for example, by a controller such as an SMC. The throttle pulse, when asserted, causes the local domains 315 to throttle, e.g., for a duration corresponding to the length of the pulse. Each of the local domains may or may not have similar throttle techniques. For example, some may run at slower rates, e.g., via clock reduction or stretching, while others may go into more aggressive lower power modes. Regardless, they will be throttled using at least one of their throttle modes by the throttle pulse, which allows for extremely fast reactivity to the over-current event.

The depicted embodiment also includes a metrics circuit 370 that generates data relating to whether and how often the Io signal goes above a separate lower threshold. The metrics circuit 370 has a lower threshold comparator 372, a programmable threshold interface 374, and a dig. LPF 376. In some embodiments, the lower threshold is set at a desired level that is lower than the upper limit max threshold. For example, it might be somewhere between 80 and 95 percent of upper max threshold. The comparator output is coupled to both a hint logic 378 and int./status registers 382 through LPF 378. When the Io signal goes above the lower threshold level and is sufficiently sustained to traverse LPF 376, it asserts at the hint logic and SMC status regs., which among other things, may track the number of these threshold crossing events over periods of time.

There may also be a hint logic control circuit 384, which may be part of an SMC or the global current limiter circuitry. The hint logic control, with or without SMC 380, may be used to tune hint logic 378. It may be tuned or controlled to monitor different metric threshold crossing events, the numbers of event crossings and also, it may be tuned or controlled to not only communicate such events with the SMC through interrupt/status registers 382, but also, it may communicate with the throttle pulse control circuit 366 to adjust throttle pulse and/or initiation settings and even to initiate a throttle pulse under appropriate conditions.

Note that in some embodiments, the lower threshold level may be adjustable, e.g., by an SMC controller to glean additional or different lo telemetry data. Along these lines, additional comparators could be used, depending on how the data is used, e.g., in a power, performance, and thermal framework management scheme. In some embodiments, a power management controller such as an SMC may adjust local domain operating points (V/F) and/or other parameters based on this data. It may adjust the lower threshold level to be able to more precisely control such operating points, depending on different factors such as operating modes and characterized workload types. For example, the SMC 380 may use heuristics to achieve efficient handling of threshold calculations and power/performance trade offs.

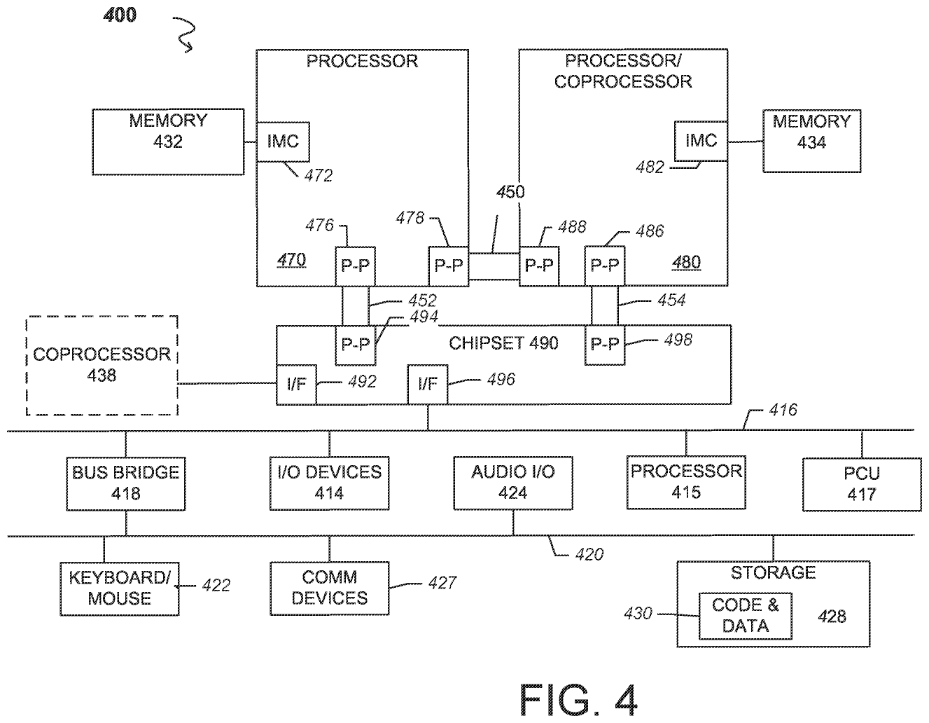

FIG. 4 illustrates an example computing system that may incorporate some or all of the current limiting circuits and/or techniques described herein. Multiprocessor system 400 is an interfaced system and includes a plurality of processors including a first processor 470 and a second processor 480 coupled via an interface 450 such as a point-to-point (P-P) interconnect, a fabric, and/or bus. In some examples, the first processor 470 and the second processor 480 are homogeneous. In some examples, first processor 470 and the second processor 480 are heterogenous. Though the example system 400 is shown to have two processors, the system may have three or more processors, or may be a single processor system. In some examples, the computing system is implemented, wholly or partially, with a system on a chip (SoC) or a multi-chip (or multi-chiplet) module, in the same or in different package combinations.

Processors 470 and 480 are shown including integrated memory controller (IMC) circuitry 472 and 482, respectively. Processor 470 also includes interface circuits 476 and 478, along with core sets. Similarly, second processor 480 includes interface circuits 486 and 488, along with a core set as well. A core set generally refers to one or more compute cores that may or may not be grouped into different clusters, hierarchal groups, or groups of common core types. Cores may be configured differently for performing different functions and/or instructions at different performance and/or power levels. The processors may also include other blocks such as memory and other processing unit engines.

Processors 470, 480 may exchange information via the interface 450 using interface circuits 478, 488. IMCs 472 and 482 couple the processors 470, 480 to respective memories, namely a memory 432 and a memory 434, which may be portions of main memory locally attached to the respective processors.

Processors 470, 480 may each exchange information with a network interface (NW I/F) 490 via individual interfaces 452, 454 using interface circuits 476, 494, 486, 498. The network interface 490 (e.g., one or more of an interconnect, bus, and/or fabric, and in some examples is a chipset) may optionally exchange information with a coprocessor 438 via an interface circuit 492. In some examples, the coprocessor 438 is a special-purpose processor, such as, for example, a high-throughput processor, a network or communication processor, compression engine, graphics processor, general purpose graphics processing unit (GPGPU), neural-network processing unit (NPU), embedded processor, or the like.

A shared cache (not shown) may be included in either processor 470, 480 or outside of both processors, yet connected with the processors via an interface such as P-P interconnect, such that either or both processors' local cache information may be stored in the shared cache if a processor is placed into a low power mode.

Network interface 490 may be coupled to a first interface 416 via interface circuit 496. In some examples, first interface 416 may be an interface such as a Peripheral Component Interconnect (PCI) interconnect, a PCI Express interconnect, or another I/O interconnect. In some examples, first interface 416 is coupled to a power control unit (PCU) 417, which may include circuitry, software, and/or firmware to perform power management operations with regard to the processors 470, 480 and/or co-processor 438. PCU 417 provides control information to one or more voltage regulators (not shown) to cause the voltage regulator(s) to generate the appropriate regulated voltage(s). PCU 417 also provides control information to control the operating voltage generated. In various examples, PCU 417 may include a variety of power management logic units (circuitry) to perform hardware-based power management. Such power management may be wholly processor controlled (e.g., by various processor hardware, and which may be triggered by workload and/or power, thermal or other processor constraints) and/or the power management may be performed responsive to external sources (such as a platform or power management source or system software).

PCU 417 is illustrated as being present as logic separate from the processor 470 and/or processor 480. In other cases, PCU 417 may execute on a given one or more of cores (not shown) of processor 470 or 480. In some cases, PCU 417 may be implemented as a microcontroller (dedicated or general-purpose) or other control logic configured to execute its own dedicated power management code, sometimes referred to as P-code. In yet other examples, power management operations to be performed by PCU 417 may be implemented externally to a processor, such as by way of a separate power management integrated circuit (PMIC) or another component external to the processor. In yet other examples, power management operations to be performed by PCU 417 may be implemented within BIOS or other system software. Along these lines, power management may be performed in concert with other power control units implemented autonomously or semi-autonomously, e.g., as controllers or executing software in cores, clusters, IP blocks and/or in other parts of the overall system. In some embodiments, PCU 417 may correspond to a SMC such as SMC 180, 280, and/or 380, implemented in separate instantiations, for example, in either or both of processors 470, 480. Along these lines, either or both of the processors 470, 480 may have Io limiting circuitry, as discussed above, for controlling a die supply current and/or for controlling internally consumed current from a plurality of different local domains within a processor or even across both processors.

Various I/O devices 414 may be coupled to first interface 416, along with a bus bridge 418 which couples first interface 416 to a second interface 420. In some examples, one or more additional processor(s) 415, such as coprocessors, high throughput many integrated core (MIC) processors, GPGPUs, accelerators (such as graphics accelerators or digital signal processing (DSP) units), field programmable gate arrays (FPGAs), or any other processor, are coupled to first interface 416. In some examples, second interface 420 may be a low pin count (LPC) interface. Various devices may be coupled to second interface 420 including, for example, a keyboard and/or mouse 422, communication devices 427 and storage circuitry 428. Storage circuitry 428 may be one or more non-transitory machine-readable storage media as described below, such as a disk drive or other mass storage device which may include instructions/code and data 430 and may implement the storage in some examples. Further, an audio I/O 424 may be coupled to second interface 420. Note that other architectures than the point-to-point architecture described above are possible. For example, instead of the point-to-point architecture, a system such as multiprocessor system 400 may implement a multi-drop interface or other such architecture.

Processor cores may be implemented in different ways, for different purposes, and in different processors. For instance, implementations of such cores may include: 1) a general purpose in-order core intended for general-purpose computing; 2) a high-performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput) computing. Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip (SoC) that may be included on the same die as the described CPU (sometimes referred to as the application core(s) or application processor(s)), the above described coprocessor, and additional functionality. Example core architectures are described next, followed by descriptions of example processors and computer architectures.

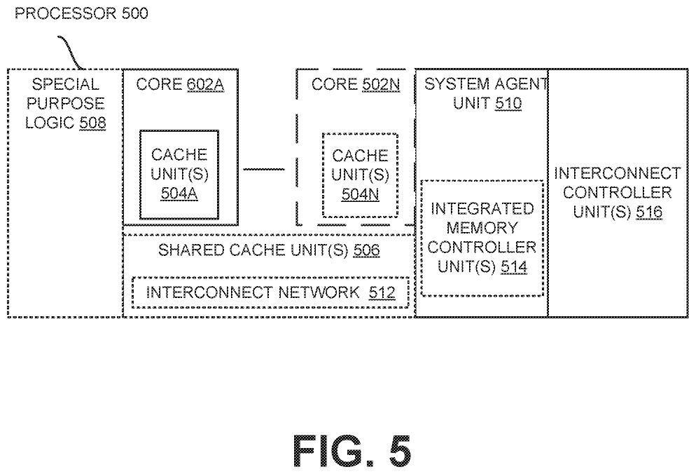

FIG. 5 illustrates a block diagram of an example processor and/or SoC 500 that may have one or more cores and an integrated memory controller. The solid lined boxes illustrate a processor 500 with a single core 502(A), system agent unit circuitry 510, and a set of one or more interface controller unit(s) circuitry 516, while the optional addition of the dashed lined boxes illustrates an alternative processor 500 with multiple cores 502(A)-(N), a set of one or more integrated memory controller unit(s) circuitry 514 in the system agent unit circuitry 510, and special purpose logic 508, as well as a set of one or more interface controller units circuitry 516. Note that the processor 500 may be one of the processors 470 or 480, or co-processor 438 or 415 of FIG. 4.

Thus, different implementations of the processor 500 may include: 1) a CPU with the special purpose logic 508 being integrated graphics and/or scientific (throughput) logic (which may include one or more cores, not shown), and the cores 502(A)-(N) being one or more general purpose cores (e.g., general purpose in-order cores, general purpose out-of-order cores, or a combination of the two); 2) a coprocessor with the cores 502(A)-(N) being a large number of special purpose cores intended primarily for graphics and/or scientific (throughput); and 3) a coprocessor with the cores 502(A)-(N) being a large number of general purpose in-order cores. Thus, the processor 500 may be a general-purpose processor, coprocessor or special-purpose processor, such as, for example, a network or communication processor, compression engine, graphics processor, GPGPU (general purpose graphics processing unit), a high throughput many integrated core (MIC) coprocessor (including 30 or more cores), embedded processor, or the like. The processor may be implemented on one or more chips. The processor 500 may be a part of and/or may be implemented on one or more substrates using any of a number of process technologies, such as, for example, complementary metal oxide semiconductor (CMOS), bipolar CMOS (BiCMOS), P-type metal oxide semiconductor (PMOS), or N-type metal oxide semiconductor (NMOS).

A memory hierarchy includes one or more levels of cache unit(s) circuitry 504(A)-(N) within the cores 502(A)-(N), a set of one or more shared cache unit(s) circuitry 506, and external memory (not shown) coupled to the set of integrated memory controller unit(s) circuitry 514. The set of one or more shared cache unit(s) circuitry 506 may include one or more mid-level caches, such as level 2 (L2), level 3 (L3), level 4 (L4), or other levels of cache, such as a last level cache (LLC), and/or combinations thereof. While in some examples interface network circuitry 512 (e.g., a ring interconnect) interfaces the special purpose logic 508 (e.g., integrated graphics logic), the set of shared cache unit(s) circuitry 506, and the system agent unit circuitry 510, alternative examples use any number of well-known techniques for interfacing such units. In some examples, coherency is maintained between one or more of the shared cache unit(s) circuitry 506 and cores 502(A)-(N). In some examples, interface controller units circuitry 516 couple the cores 502 to one or more other devices 518 such as one or more I/O devices, storage, one or more communication devices (e.g., wireless networking, wired networking, etc.), etc.
Example 1 is an apparatus that includes a VR load, a voltage regulator (VR) rail, and a droop detection circuit. The VR rail is to provide a supply voltage to the VR load. The droop detection circuit is to monitor the supply voltage and assert a throttle to the VR load to cause it to reduce current consumption when the supply voltage reaches or goes below a voltage trip level. The voltage trip level is set based on the current sourcing capability of a voltage regulator that is to generate the supply voltage.
Example 2 includes the subject matter of example 1, and wherein the droop detection circuit has a programmable voltage trip threshold level that is higher than a minimum supply voltage needed to prevent the VR load from becoming inactive.
Example 3 includes the subject matter of any of examples 1-2, and wherein the droop detection circuit has a programmable debounce filter coupled between the VR rail and an input of a comparator used to compare the supply voltage with the voltage trip level.
Example 4 includes the subject matter of any of examples 1-3, and further comprising a system management controller (SMC) circuit configured to control the VR load to run at current levels that exceed a maximum current capability from the VR supplying the voltage supply to the VR rail.
Example 5 includes the subject matter of any of examples 1-4, and wherein the VR load includes a compute cores domain, and the asserted throttle causes at least some cores within the compute cores domain to run at lower frequencies.
Example 6 includes the subject matter of any of examples 1-5, and wherein the asserted throttle causes the at least some cores within the compute cores domain to run at lower frequencies without having to stop the cores from running.
Example 7 includes the subject matter of any of examples 1-6, and wherein the integrated circuit is an SoC die, and the SoC VR load includes a compute core complex.
Example 8 includes the subject matter of any of examples 1-7, and wherein the VR rail is to receive the supply voltage from a voltage regulator external to the SoC.
Example 9 includes the subject matter of any of examples 1-8, and wherein the SoC has multiple voltage supply rails to receive supply voltages from additional external voltage regulators.
Example 10 is a system that includes a voltage regulator and a droop detection circuit. The voltage regulator (VR) is to provide a supply voltage to a VR load having one or more functional blocks in an integrated circuit (IC). The droop detection circuit is to monitor the supply voltage and assert a throttle to the VR load to cause it to reduce current consumption when the supply voltage goes sufficiently below a voltage trip threshold. The VR being configured to limit its current output at a predefined maximum level and transition into a constant current mode when it reaches that level.
Example 11 includes the subject matter of example 10, and wherein the droop detection circuit has a programmable voltage trip threshold level that is higher than a minimum supply voltage needed to prevent the VR load from becoming inactive.
Example 12 includes the subject matter of any of examples 10-11, and further comprising a system management controller (SMC) circuit configured to control the VR load to run at current levels that exceed the predefined maximum current level of the VR.
Example 13 includes the subject matter of any of examples 10-12, and wherein the VR load includes a compute cores domain, and the asserted throttle causes at least some cores within the compute cores domain to run at lower frequencies without having to change operating states controlled by an operating system.
Example 14 includes the subject matter of any of examples 10-13, and wherein the voltage trip level is defined to trip after the voltage regulator goes into the constant current mode.
Example 15 includes the subject matter of any of examples 10-14, and wherein the integrated circuit is a processor.
Example 16 includes the subject matter of any of examples 10-15, and wherein the processor includes first and second processor dies each having separate VR loads to be supplied by separate voltage regulators.
Example 17 is an integrated circuit apparatus that includes a global current domain, adder circuitry, and a limiter circuit. The global current domain has a plurality of local domains each to consume an associated local domain current. Each local domain has an associated current sense circuit to provide a sensed current value for its associated local domain. The adder circuitry is to sum together the plurality of sensed local domain currents to generate an overall current level. The limiter circuit has an upper threshold level and is to receive the overall current level and assert a throttle when the current level sufficiently goes above the upper threshold. The asserted throttle is to cause the local domains to throttle down their power consumption.
Example 18 includes the subject matter of example 17, and wherein the local domains and limiter circuit are on the same die.
Example 19 includes the subject matter of examples 17-18, and wherein the current sense circuits are each part of a separate VR that is to provide a supply voltage to an associated local domain.
Example 20 includes the subject matter of examples 17-19, and wherein the VRs are digital voltage regulators having digital voltage control values used by the sense circuits to provide the sensed current values.
Example 21 includes the subject matter of examples 17-20, and wherein the adder circuit comprises multiple sub-adder circuits, each to receive some of the sensed sub-domain current values from at least two local domains.
Example 22 includes the subject matter of examples 17-21, and wherein the sub-adders are coupled to at least one higher level adder circuit to generate the overall SoC current signal.
Example 23 includes the subject matter of examples 17-22, and further comprising a lower level threshold detector circuit with an adjustable lower level threshold to provide metrics for an SMC to implement a power and performance management function.
Example 24 includes the subject matter of examples 17-23, and wherein the lower threshold detector circuit is coupled to the SMC through an interrupt register to allow it to generate an interrupt to the SMC.
Example 25 includes the subject matter of examples 17-24, and wherein the Current domain is part of a system on chip (SoC), and first one of the local domains includes a plurality of compute cores.
Example 26 includes the subject matter of examples 17-25, and wherein a second one of the local domains includes a graphics processing unit.
Example 27 includes the subject matter of examples 17-26, and wherein the SoC comprises first and second processor dies, each having a separate Current domain with separate local domains.

Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances of “an embodiment,” “one embodiment,” or “some embodiments” are not necessarily all referring to the same embodiments. If the specification states a component, feature, structure, or characteristic “may,” “might,” or “could” be included, that particular component, feature, structure, or characteristic is not required to be included.

Throughout the specification, and in the claims, the term “connected” means a direct connection, such as electrical, mechanical, or magnetic connection between the things that are connected, without any intermediary devices.

The term “coupled” means a direct or indirect connection, such as a direct electrical, mechanical, or magnetic connection between the things that are connected or an indirect connection, through one or more passive or active intermediary devices.

The term “circuit” or “module” may refer to one or more passive and/or active components that are arranged to cooperate with one another to provide a desired function. It should be appreciated that different circuits or modules may consist of separate components, they may include both distinct and shared components, or they may consist of the same components. For example, A controller circuit may be a first circuit for performing a first function, and at the same time, it may be a second controller circuit for performing a second function, related or not related to the first function.

The meaning of “in” includes “in” and “on” unless expressly distinguished for a specific description.

The terms “substantially,” “close,” “approximately,” “near,” and “about,” unless otherwise indicated, generally refer to being within +/−10% of a target value.

Unless otherwise specified, the use of the ordinal adjectives “first,” “second,” and “third,” etc., to describe a common object, merely indicate that different instances of like objects are being referred to and are not intended to imply that the objects so described must be in a given sequence, either temporally, spatially, in ranking or in any other manner

For the purposes of the present disclosure, phrases “A and/or B” and “A or B” mean (A), (B), or (A and B). For the purposes of the present disclosure, the phrase “A, B, and/or C” means (A), (B), (C), (A and B), (A and C), (B and C), or (A, B and C).

In addition, well-known power/ground connections to integrated circuit (IC) chips and other components may or may not be shown within the presented figures, for simplicity of illustration and discussion, and so as not to obscure the disclosure. Further, arrangements may be shown in block diagram form in order to avoid obscuring the disclosure, and also in view of the fact that specifics with respect to implementation of such block diagram arrangements are dependent upon the platform within which the present disclosure is to be implemented.

As defined herein, the term “if” means “when” or “upon” or “in response to” or “responsive to,” depending upon the context. Thus, the phrase “if it is determined” or “if [a stated condition or event] is detected” may be construed to mean “upon determining” or “in response to determining” or “upon detecting [the stated condition or event]” or “in response to detecting [the stated condition or event]” or “responsive to detecting [the stated condition or event]” depending on the context. As defined herein, the term “responsive to” means responding or reacting readily to an action or event. Thus, if a second action is performed “responsive to” a first action, there is a causal relationship between an occurrence of the first action and an occurrence of the second action. The term “responsive to” indicates the causal relationship.

As defined herein, the term “processor” means at least one hardware circuit configured to carry out instructions contained in program code. The hardware circuit may be implemented with one or more integrated circuits. Examples of a processor include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, a graphics processing unit (GPU), a controller, and so forth, as well as any suitable combinations of the same such as systems on a chip (SoC), which may include several different processing circuits such as CPU cores, graphics processing cores, digital signal processing (DSP) circuits, etc. It should be appreciated that a logical processor, on the other hand, is a processing abstraction associated with a core, for example when one or more SMT cores are being used such that multiple logical processors may be associated with a given core, for example, in the context of core thread assignment.

The flowchart and block diagrams in the figures illustrate the architecture, functionality, and operation of possible implementations of systems, methods, and computer program products according to some embodiments. In this regard, each block in the flowchart or block diagrams may represent a module, segment, or portion of instructions, which comprises one or more executable instructions for implementing the specified operations.

What is claimed is:

1. An apparatus, comprising:
a VR load;
a voltage regulator (VR) rail to provide a supply voltage to the VR load; and
a droop detection circuit to monitor the supply voltage and assert a throttle to the VR load to cause it to reduce current consumption when the supply voltage reaches or goes below a voltage trip level, the voltage trip level set based on a current sourcing capability of a voltage regulator that is to generate the supply voltage.

2. The apparatus of claim 1, wherein the droop detection circuit has a programmable voltage trip threshold level that is higher than a minimum supply voltage needed to prevent the VR load from becoming inactive.

3. The apparatus of claim 2, wherein the droop detection circuit has a programmable debounce filter coupled between the VR rail and an input of a comparator used to compare the supply voltage with the voltage trip level.

4. The apparatus of claim 2, further comprising a system management controller (SMC) circuit configured to control the VR load to run at current levels that exceed the maximum current capability from the VR supplying the voltage supply to the VR rail.

5. The apparatus of claim 1, wherein the VR load includes a plurality of compute cores, and the asserted throttle causes at least some of the plurality of compute cores to run at lower frequencies.

6. The apparatus of claim 5, wherein the asserted throttle causes the at least some cores within the compute cores domain to run at lower frequencies without having to stop the cores from running.

7. The apparatus of claim 1, wherein the VR load is part of a SoC (system on chip) die that includes a compute core cluster.

8. A system, comprising:
a voltage regulator (VR) to provide a supply voltage to a VR load having one or more functional blocks in an integrated circuit (IC); and
a droop detection circuit to monitor the supply voltage and assert a throttle to the VR load to cause it to reduce current consumption when the supply voltage goes sufficiently below a voltage trip threshold, wherein the VR is configured to limit its current output at a predefined maximum level and transition into a constant current mode when it reaches that level.

9. The system of claim 8, wherein the droop detection circuit has a programmable voltage trip threshold level that is higher than a minimum supply voltage needed to prevent the VR load from becoming inactive.

10. The system of claim 9, further comprising a system management controller (SMC) circuit to control the VR load to run at current levels that exceed the predefined maximum current level of the VR.

11. The system of claim 8, wherein the VR load includes a plurality of compute cores, and the asserted throttle causes at least some cores within the plurality of compute cores to run at lower frequencies without having to change operating states controlled by an operating system.

12. The system of claim 8, wherein the voltage trip threshold is defined to trip after the voltage regulator goes into the constant current mode.

13. The system of claim 8, wherein the integrated circuit is a processor.

14. The system of claim 13, wherein the processor includes first and second processor dies each having separate VR loads to be supplied by separate voltage regulators.

15. An apparatus, comprising:
a global domain having a plurality of local domains each to consume an associated local domain current, each local domain having an associated current sense circuit to provide a sensed current value for its associated local domain current;
adder circuitry to sum together the plurality of sensed local domain currents to generate an overall current level; and
a limiter circuit having an upper threshold level, the limiter circuit to receive the overall current level and assert a throttle when the overall current level sufficiently goes above the upper threshold, the asserted throttle to cause the local domains to throttle down their power consumption.

16. The apparatus of claim 15, wherein the local domains and limiter circuit are on the same die.

17. The apparatus of claim 16, wherein the current sense circuits are each part of a separate VR that is to provide a supply voltage to an associated local domain.

18. The apparatus of claim 17, wherein the VRs are digital voltage regulators having digital voltage control values used by the sense circuits to provide the sensed current values.

19. The apparatus of claim 15, wherein the adder circuit comprises multiple sub-adder circuits, each to receive sensed local domain current values from at least two local domains.

20. The apparatus of claim 19, wherein the sub-adders are coupled to at least one higher level adder circuit to generate the overall current level.
